(19) United States
(12) Patent Application Publication
(10) Pub. No.: US 2014/0129523 A1
(43) Pub. Date: May 8, 2014

(54) METHOD & APPARATUS FOR ENABLING AUDITING OF A POSITION BY CREATING A CHAIN OF ACTIVE & INACTIVE RECORDS

(71) Applicant: Callidus Software Incorporated, Pleasanton, CA (US)

(72) Inventor: Fok-Kuong Cheang, Union City, CA (US)

(73) Assignee: Callidus Software Incorporated, Pleasanton, CA (US)

(21) Appl. No.: 13/725,263

(22) Filed: Dec. 21, 2012

Related U.S. Application Data
(63) Continuation of application No. 13/672,401, filed on Nov. 8, 2012.

(51) Int. Cl. G06F 17/30

(52) U.S. Cl. CPC G06F 17/30368
USPC 707/648

(57) ABSTRACT

A computing apparatus and method of recalculating upon changes to data by saving changes to the data; receiving a request to recalculate a result according to the data; retrieving only active data from the data according to the saved changes to the data; and recalculating the result based upon the active data.

### FIELD

The embodiments relate to computer implemented calculations based upon active data.

### BACKGROUND

Traditional data management system does not keep track of data change or detect data change, so any change in reference data and transaction data will require a recalculation of all the results again.

### SUMMARY

According to an embodiment of the present invention, a computer system is controlled to perform a calculation based upon a rule (reference data) and corresponding data for the rule by utilizing active data for the rule and/or for the corresponding data.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1 is a functional block diagram of a computer system that calculates based upon active data, according to an embodiment of the invention.

FIG. 2 is a diagram of example data models for reference data and transaction data, according to an embodiment of the invention.

FIG. 3 is a diagram of changes to example reference data and transaction data, according to an embodiment of the invention.

FIG. 4 is a flow chart of calculating a result according to active data, according to an embodiment of the invention.

FIG. 5A is a flow chart of calculating financial commissions in a commission management computer system, according to an embodiment of the invention.

FIGS. 5B and 5C are dependency graphs of example data models with relational metadata, according to an embodiment of the invention.

FIG. 6 is a functional block diagram of a computer for the embodiments of the invention.

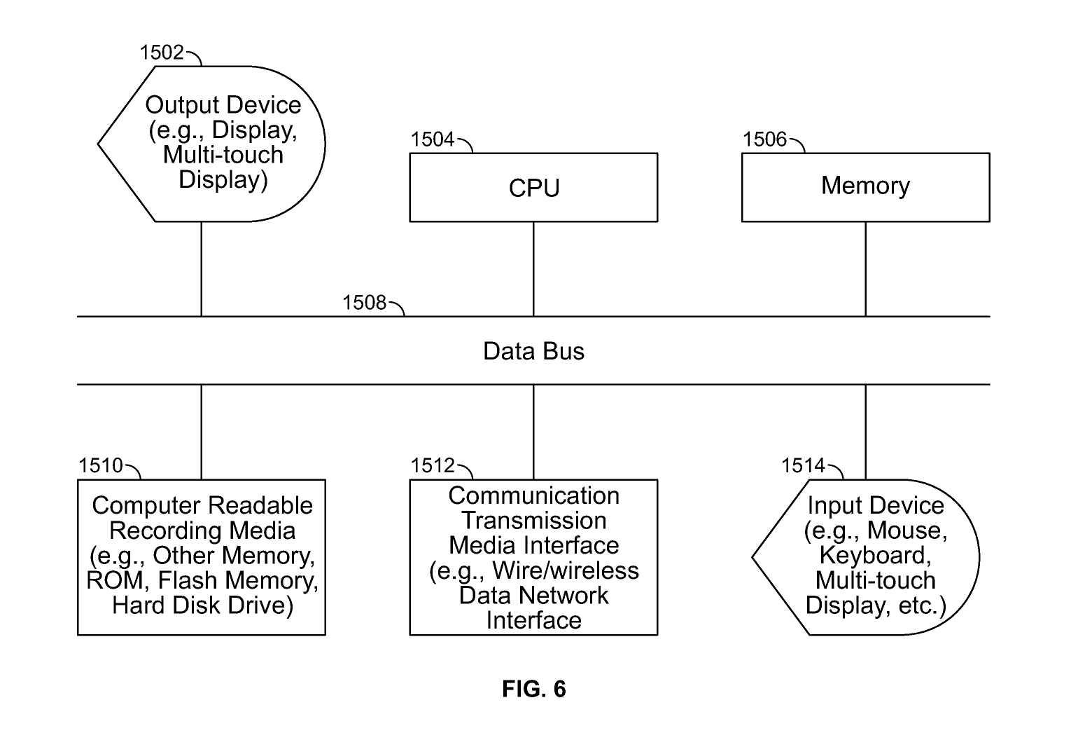

### DETAILED DESCRIPTION OF EMBODIMENT(S)

The embodiments relate to calculating based upon active data or data that has been most recently changed in relation to a time threshold. An example embodiment is described in connection with a financial commission management system, however, the present invention is not limited as such and is directed to a computer system controlled to perform a calculation based upon a rule (reference data) and corresponding data for the rule by utilizing active data for the rule and for the corresponding data.

For example, in case of a commission management system, a computer system stores and calculates commissions for sales representatives for a set of defined rules as reference data, for example, compensation rules and data provided for the rule or data to which the rule is applied, namely transaction data, such as sales transactions data.

The present invention is a new approach of calculating commissions in the commission management system. Traditional commission management system does not keep track of data change or detect data change, so any change in the reference data (i.e. data related to sales representatives, compensation rules and the elements used in the compensation rules) and transaction data (i.e. sales transaction) will require a recalculation of all the results again. The disadvantage is that the calculation when data has been changed recalculates results that have not changed which do not require recalculation. This kind of system becomes very inefficient if the change only affects a very small number of sales representatives and it has to recalculate results for all the unaffected sales representatives.

According to an aspect of an embodiment, changes to the reference data and transaction data are tracked and any results are recalculated only with respect to data affected by the changes.

According to an aspect of an embodiment, a persistence layer and a data model that supports temporal data as a way to keep track of data change are provided. A calculation engine can recalculate results, for example, financial commissions, for the changed data including data affected by the changed data (collectively referred to as active data).

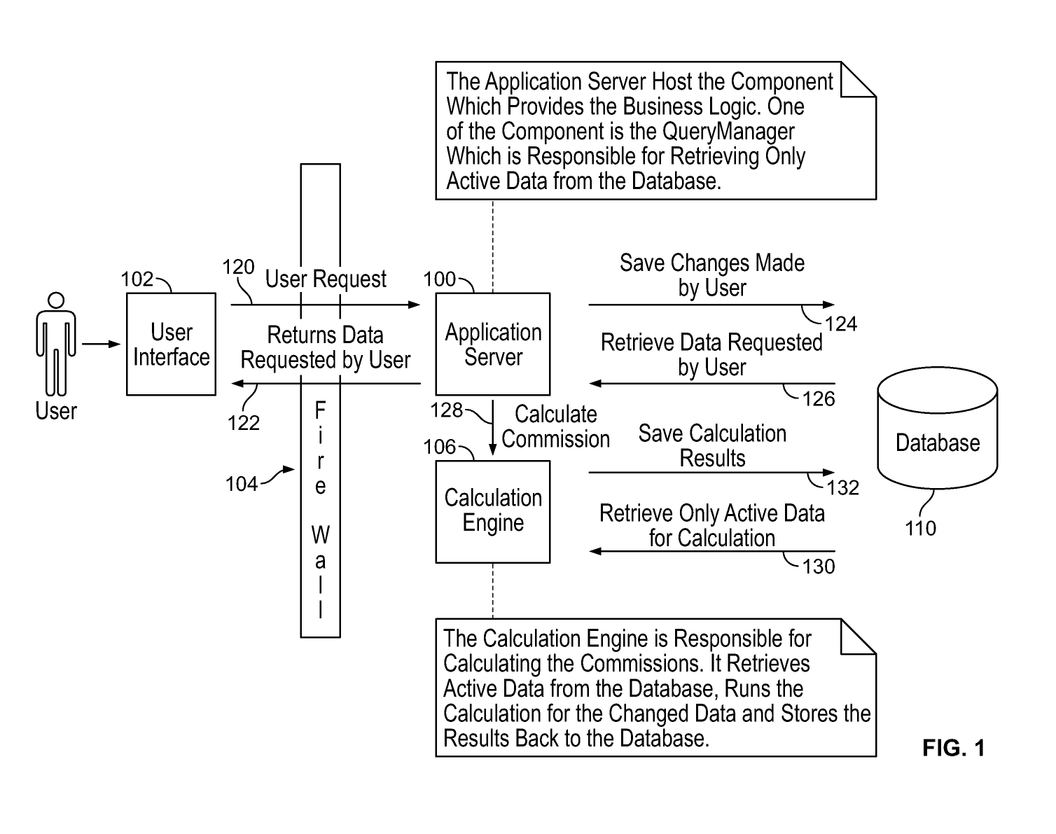

FIG. 1 is a functional block diagram of a computer system that calculates based upon active data, according to an embodiment of the invention. In FIG. 1, a user accesses a computer implemented service on an application server 100 by way of a user interface 102 to the computer application server 100. The application server 100 functions are referred to as the persistence layer. The user interface 100 may be over a data communication network 104. Typically, an application server 100 executes a business logic that calculates one or more results based upon data, for example, a commission management system that calculates commissions for sales representatives for a set of defined compensation rules (reference data) and sales transactions (transaction data). The calculations may be performed by a calculation engine 106, which can be implemented on the application server 100 and/or remotely over a network by another computer 106, by accessing transaction data that includes temporal attributes (temporal data model), for example, transaction data stored in a database 110. A network can be the Internet.

In FIG. 1, at 120 a user (or device) can request data from the application server 100 and at 122, the application server returns the requested data. In addition, a data request can involve changes to the data, where at 123, the application server 100 saves data changes requested by the user. A data request can also involve retrieving data, where at 126, the application server 100 retrieves data requested by the user. In addition, a data request can involve a calculation request, where the application server 100 executes a query manager that retrieves only active data from the database 110. The calculation engine 106 makes a calculation based upon only the active data. According to an aspect of an embodiment, at 128, the calculation engine 106 receives a calculation request from the application server 100, at 130 retrieves only active data for the calculation from the database 110 and calculates based upon only the active data, and at 132 saves the calculation result to the database 110.

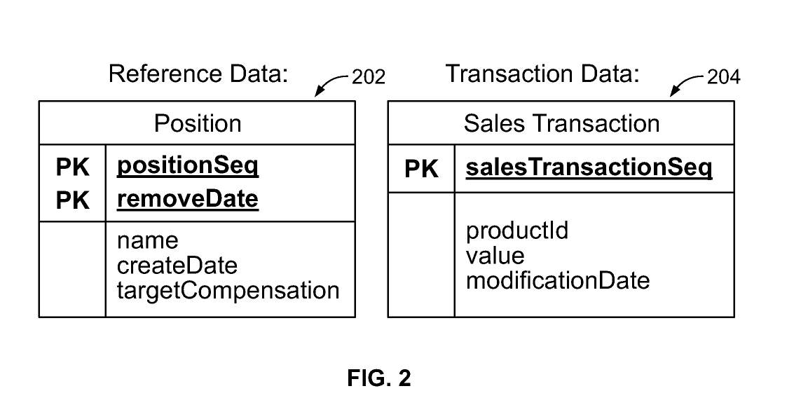

FIG. 2 is a diagram of example data models for temporal reference data and transaction data, according to an embodiment of the invention. The temporal data can be stored in the database 110. For example, the temporal data model is implemented by adding temporal attributes to data, for example, the “createDate” and “removeDate” attribute are added to the reference data. In case of large volume of data, for example for transaction data, a different approach is taken by adding a modificationDate attribute and whether when a transaction was created or removed may not need to tracked. A modificationDate attribute identifies or specifies when a particular transaction was last changed.

In FIG. 2, an example of reference data 202, namely “Position” of a person in an organization, and transaction data 204, namely “SalesTransaction,” are illustrated with the new temporal attributes for these two types of data.

The persistence layer used by the data entry user interface 102 handles temporal data. Specifically, the query manager in the persistence layer at the application server 100 constructs a query to fetch only the active data (i.e. data last modified and/or created including data affected by the modification and/or creation) by utilizing applicable temporal attributes. The persistence layer handles a reference data change by end dating an existing data record by setting the temporal attribute “removeDate” to the current time and creating a new record with the change and setting the new record's temporal attribute “createDate” to current time and the new record's temporal attribute removeDate to an arbitrary value that signifies end of time. For changes in the transactional data, the persistence layer updates the temporal attribute “modification Date” on the record along with the changes.

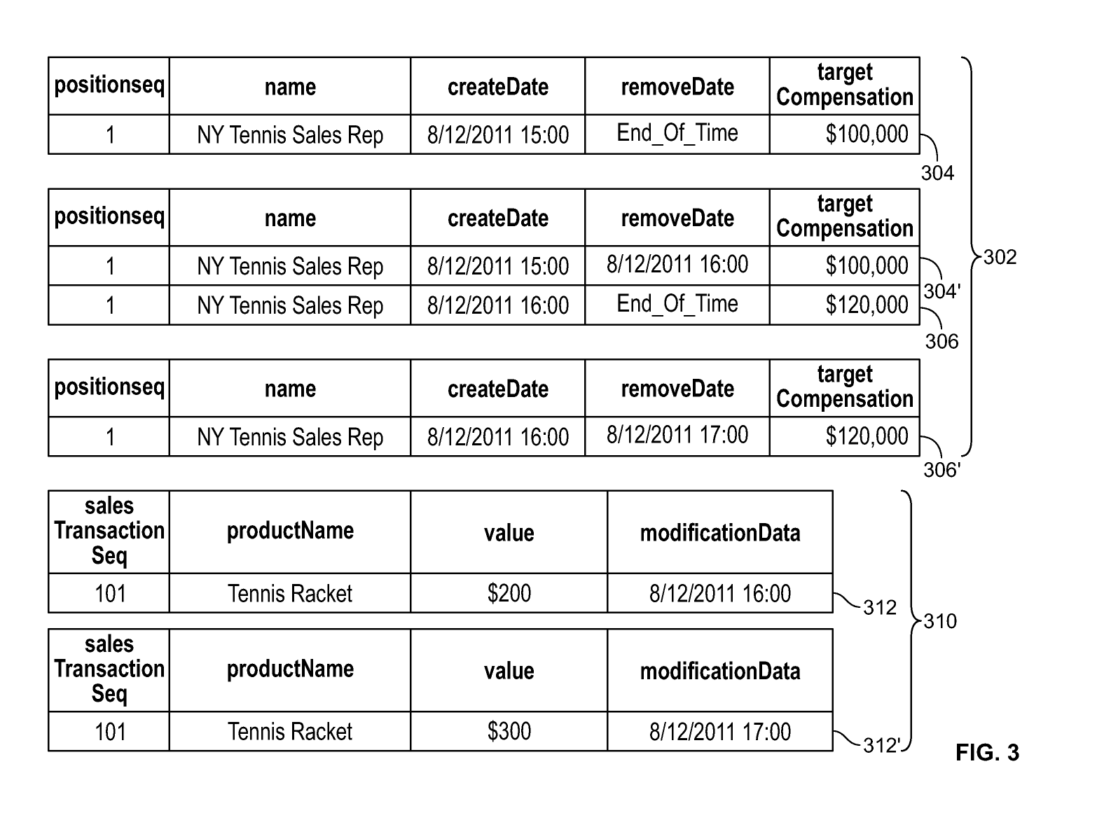

FIG. 3 is a diagram of changes to example reference data and transaction data, according to an embodiment of the invention. In FIG. 3, the example 302 shows a sequence of events when a user changes reference data, namely information of a sales person in an organization. In FIG. 3, in 304 a new position “NY Tennis Sales Rep” is added to the system at 3 pm on Aug. 12, 2011. In FIG. 3, the targetCompensation for this new position is changed to $120,000 at 4 pm on Aug. 12, 2011, therefore, the temporal attributes of the existing record 304 created on Aug. 12, 2011 at 3 pm is updated, for example, in 304′ the “removeDate” is changed from End_of_Time to a current time of change, and a new record 306 is created with new temporal attributes, for example, the “createDate” is changed to a current time of change and the “removeDate” is changed to End_of_Time.

In FIG. 3, the position is removed from the system at 5 pm on Aug. 12, 2011, therefore, the temporal attributes of the active record 306 most recent created on Aug. 12, 2011 at 4 pm is updated, for example, in 306′ the “removeDate” is changed from End_of_Time to a current time of change of Aug. 12, 2011 at 5 pm.

In FIG. 3, the example 310 shows a sequence of events when user changes the transaction data. The record 312 is a new transaction added for “Tennis Racket” at 4 pm on Aug. 12, 2011. In record 312′, the transaction value is changed to $300 at 5 pm on Aug. 12, 2011, where the temporal attributes “modificationDate” is changed from Aug. 12, 2011, 4 pm to Aug. 12, 2011 at 5 pm.

According to an aspect of an embodiment, temporal attributes are utilized in a manner to easily and efficiently maintain a record (log) of chain of changes to the reference data for audit purposes. The embodiments of the invention are not limited to the described temporal attributes and other forms of temporal attributes can be provided. For example, any combination of one or more of the “createDate” and “removeDate” temporal attributes can be provided, and/or a single “modificationDate” temporal attribute can be utilized in the reference data and/or the transaction data. According to an aspect of an embodiment, creation of a new record with updated temporal attributes upon a data change (update and/or remove) can be omitted by way of a single temporal attribute along with other added attributes to identify a chain of changes. In addition, while temporality as a most recent or active information has been described in relation to time information, the embodiments are not limited as such and other information, such as a counter, entity organization information, etc. can be utilized to convey such temporality. [NOTE: This paragraph attempts to extend the concept of temporal attributes and maintaining a log of chain of changes—please confirm and add/modify as appropriate.]

When a user requests to recalculate one or more commissions after making some changes to the data, a request will be sent to the calculation engine 106 to start the commission calculation process. The calculation engine calculation engine 106 is able to calculate based upon only the data that has changed and data affected by changes (collectively referred to as active data).

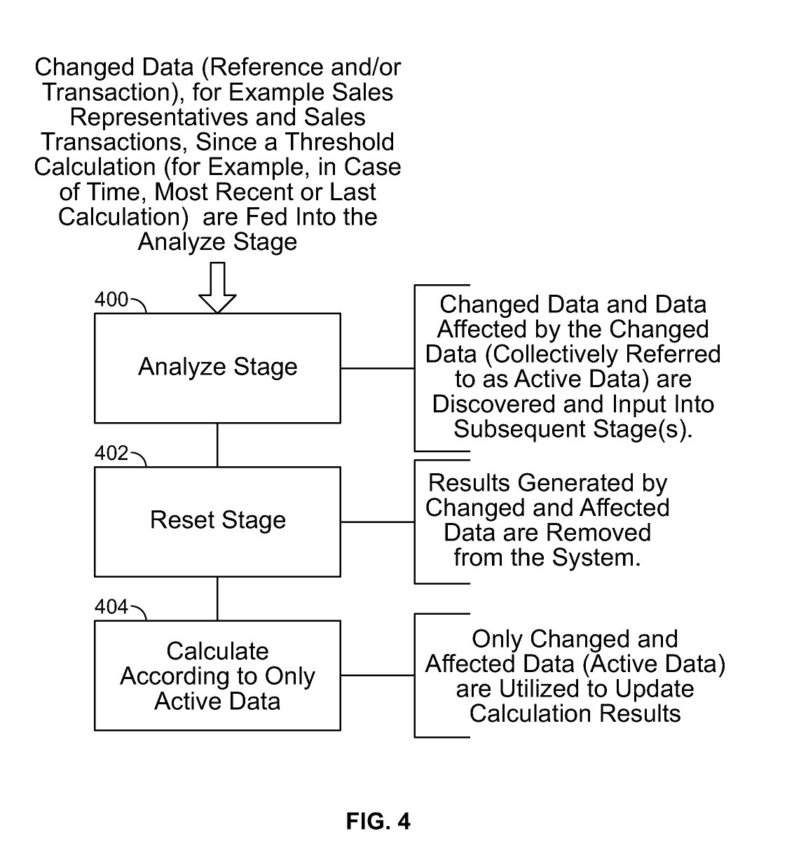

FIG. 4 is a flow chart of calculating a result according to active data, according to an embodiment of the invention. The calculation process starts at 400 by first running the Analyze stage (A stage is a phrase during the entire calculation process, each stage will take input data from prior stage and generates results for the next stage to use). In particular, at 400, changed data (reference and/or transaction), for example sales representatives information and sales transaction information, since a threshold calculation (for example, in case of time, most recent or last calculation) are retrieved by utilizing temporal attributes of the reference and/or transaction data. In addition, at 400, changed data and data affected by or dependent on the changed data (collectively referred to as active data) are discovered according to metadata relationships included in data models for the reference and/or transaction data [NOTE: Any new metadata developed as a feature for navigation?]. At 400, the active data is input into subsequent stage(s). At 400, the delta or difference between inputs to the persistence layer that have made changes in relation to other data is automatically detected and discovered by way of temporal attributes for the data. Therefore, the output from the Analyze Stage 400 is a set of active only reference and/or transaction data that will need to be used for recalculation. The result of this stage is persisted into a database which will be used by a subsequent stage to carry out the incremental calculation.

In FIG. 4, at the reset stage 402, results generated by changed and affected or dependent data (active data) are removed from the persistence layer. At 404, only active data is utilized to update or recalculate results, providing an incremental calculation that is significantly more efficient (reduces or faster computer processing time, and reduces computer hardware costs) than a recalculation of all results.

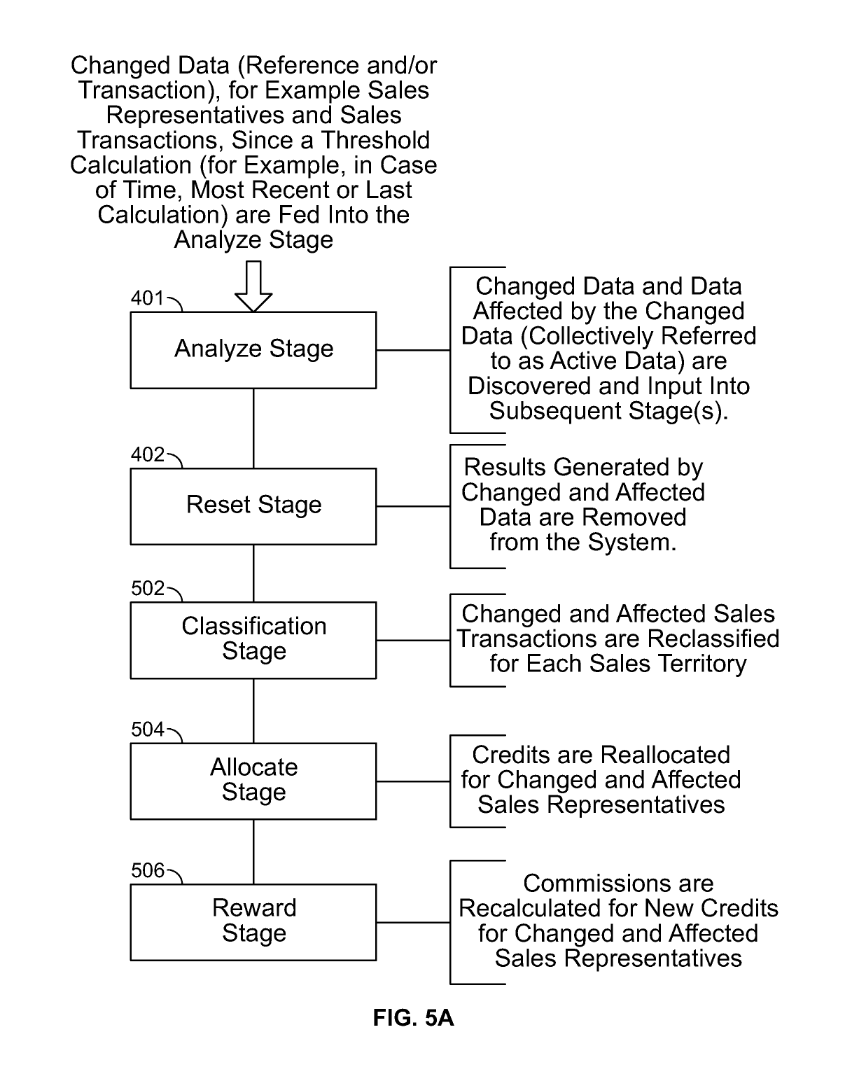

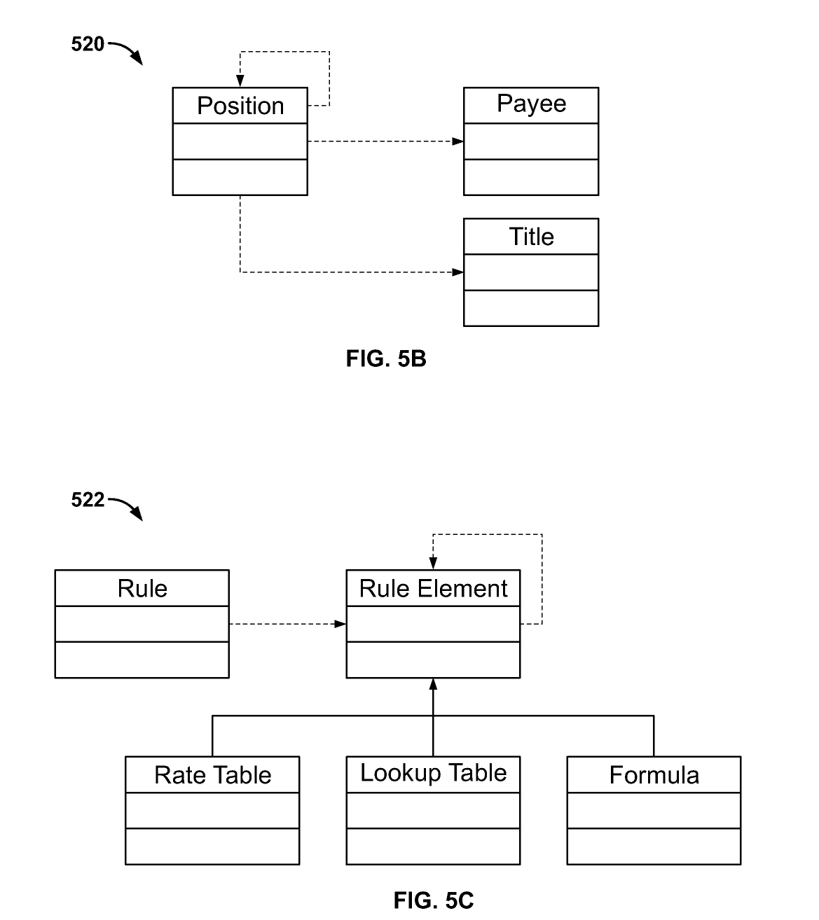

FIG. 5A is a flow chart of calculating financial commissions in a commission management computer system, according to an embodiment of the invention. FIGS. 5B and 5C are dependency graphs of example data models with relational metadata, according to an embodiment of the invention. At 401, changed data (reference and/or transaction), for example sales representatives information and sales transaction information, since a threshold calculation (for example, in case of time, most recent or last calculation) are retrieved by utilizing temporal attributes of the reference and/or transaction data. In addition, at 401, changed data and data affected by or dependent on the changed data (collectively referred to as active data) are discovered according to metadata relationships included in data models for the reference and/or transaction data.

According to an aspect of an embodiment of the invention, at 401, analyze stage starts by loading reference data and/or transaction data that is created or modified since a threshold calculation, for example, the most recent calculation. Reference data can be retrieved with a temporal attribute based query similar to the following from the temporal data model 110:
select * from Position where createDate>date_of_last_calculation

Transaction data can be retrieved similarly with the following query:
select * from SalesTransaction where modificationDate>date_of_last_calculation

In addition, at 401, the retrieved changed data will be examined to discover the dependent data that also need to be re-calculated. FIG. 56 is a dependency graph of a data model 520 for the position reference data that includes a position of a person in an organization with payee and a title information. To determine the affected position (position that a re-calculate of their results is requested), the dependency graph of the position is navigated by way of a computer implemented interface starting with the position that is changed. The dependency between the position object and other reference data is captured in the data model through referential integrity. As shown in FIG. 56, the Payee is assigned to the Position (i.e. someone was hired to fill the Position), and the Position is assigned with a Title (a title is a classification of the Position) and a manager (which itself is a Position) is assigned to the Position. So in this graph the Position depends on the Payee, Title and subordinate Position. Any change in the Title and Payee will affect the Position to which it is assigned to and any change in the Position will affect the manager of this position.

Conceptually, the algorithm to calculate the affected position can work as follow:
for each Position changed since last calculation→add it to the list
for each Payee changed since last calculation→find the Position it assigned to and add it to the list
for each Title changed since last calculation→find the Position assigned with this title and add it to the list
loop until there is no more position added to the list
for each position in the list→add the manager position to the list

Similarly, the affected rules as another reference data can be determined by navigating the dependency graph 522 in FIG. 5C for the rule shown in FIG. 5C.

In FIG. 5C, for example, a rule is constructed with RuleElements (Rule Elements are reusable objects that can be built into compensation rules or other calculations to return a value or set of values. For example, in a commission management system, any of the following can be considered Rule Elements: Territories, Fixed Values, Quotas, Rate Tables, Lookup Tables, and Formulas). So a Rule depends on Rule Element, i.e. any change in the Rule Element will affect the Rule that uses the Rule Element. Since a nested formula can be provided and formulas can be used within Lookup table and Rate table, a Rule Element can also depend on other Rule Element.

Conceptually, the operations to determine the affected rules can be as follow:
for each Rule Element changed since last calculation→add it to the list
loop until there is no more Rule Element added to the list
for each Rule Element in the list→find the dependent Rule Element and add it to the list
for each Rule Element in the list→find the rule that uses it and add it to the list

If data, for example in this case sales transaction data, does not depend on anything, a query issued to retrieve the changed sales transactions since a threshold calculation would be sufficient. Once the changed and affected data (active data) are discovered, it will be persisted to a database to be used by subsequent stage(s).

In Reset stage 402, the results generated from changed and affected data will be removed from the database 110.

In the Classification stage 502, the changed and affected sales transactions (active data) can be classified, for example will be classified to the corresponding sales territory defined by the classification rules.

In Allocate stage 504, credits will be re-allocated by processing all the changed compensation rules for all the changed sales transactions and positions.

In the last stage, Reward stage 506, new credits created from Allocate stage will be used to process compensation rules for all the positions to create commissions which will be pay out to the position.

FIG. 9 is a functional block diagram of a computer (hardware computing machine) for the embodiments of the invention, namely a computer configured to execute a calculation based upon changed data. In FIG. 9, the computer can be any computing device that can execute instructions to provide the described functions. Typically, the computer includes an input device 1514 (for example, a mouse, keyboard, multi-touch display screen, etc.), output device 1502 (for example, a display to display a user interface or output information, printer, etc.). One or more computer controller(s) or processing cores 1504 (e.g., a hardware central processing unit) executes instructions (e.g., a computer program or software) that control the apparatus to perform operations. According to an aspect of an embodiment, one or more networked computer servers, each with a number of processing cores, execute the described operations.

Typically, a memory component 1506 stores the instructions for execution by the controller 1504. According to an aspect of an embodiment, the apparatus reads/writes/processes data of any computer readable recording media 1510 and/or communication transmission media interface 1512. The communication transmission media interface is to data network with one or other machines (e.g., computers) to execute the described functions. The embodiments can be implemented via grid computing. The display 1502, the CPU 1504 (e.g., hardware logic circuitry based computer processor that processes instructions, namely software), the memory 1506, the computer readable media 1510, and the communication transmission media interface 1512 are in communication by one or more the data bus(es) 1508.

According to an aspect of the embodiments of the invention, any combinations of one or more of the described features, functions, operations, and/or benefits can be provided. A combination can be one or a plurality. The embodiments can be implemented as an apparatus (a machine) that includes hardware for performing the described features, functions, operations, and/or benefits, for example, hardware to execute instructions or software, for example, computing hardware (i.e., computing apparatus), such as (in a non-limiting example) any computer or computer processor that can store, receive, retrieve, process and/or output data and/or communicate (network) with other computers. According to an aspect of an embodiment, the described features, functions, operations, and/or benefits can be implemented by and/or use computing hardware and/or software. For example, the application server 100, a client terminal implementing the user interface 102, a calculation engine 106, can comprise a computing controller (CPU) (e.g., a hardware logic circuitry based computer processor that processes or executes instructions, namely software/program), computer readable media, transmission communication interface (network interface), input device, and/or an output device, for example, a display device, and which can be in communication among each other through one or more data communication buses. In addition, an apparatus can include one or more apparatuses in computer network communication with each other or other devices. In addition, a computer processor can refer to one or more computer processors in one or more apparatuses or any combinations of one or more computer processors and/or apparatuses. An aspect of an embodiment relates to causing and/or configuring one or more apparatuses and/or computer processors to execute the described operations. The results produced can be output to an output device, for example, displayed on the display. An apparatus or device refers to a physical machine that performs operations, for example, a computer (physical computing hardware or machinery) that implement or execute instructions, for example, by way of software, which is code executed by computing hardware, and/or by way of computing hardware (e.g., in circuitry, etc.), to achieve the functions or operations being described. The functions of embodiments described can be implemented in any type of apparatus that can execute instructions or code. More particularly, programming or configuring or causing an apparatus or device, for example, a computer, to execute the described functions of embodiments of the invention creates a new machine where in case of a computer a general purpose computer in effect becomes a special purpose computer once it is programmed or configured or caused to perform particular functions of the embodiments of the invention pursuant to instructions from program software.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc—Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A system for enabling the auditing of a position by creating a chain of active and non-active records, comprising:
processing an audit record that automatically detects changes to data and recalculates upon changes to data, comprising:
a computer processor controlled to execute:
detecting changes to the audit record;
saving the changes to the audit record;
receiving a request to recalculate a result according to the data;
retrieving only active records from the data according to the saved changes to the data; and
recalculating the result based upon the active records.

2. The system according to claim 1, wherein the active records are stamped at the time of creation and any prior records are deactivated at the same time.

3. The system according to claim 2, wherein the prior records comprise records that existed before the active records are time-stamped.

4. The system according to claim 1, wherein all non-active records are retained for auditing.

5. The system according to claim 4, wherein all active and non-active records are combined to create an audit trail.

6. The system according to claim 5, wherein a report is generated from the audit trail.

7. The system according to claim 6, wherein the report comprises user data, such as who made the changes to the active records, and the time that such changes were made.

8. A method for enabling auditing of a position by creating a chain of active and non-active records, comprising:
configuring a computer to execute:
detecting changes to the audit record;
saving the changes to the audit record;
receiving a request to recalculate a result according to the data;
retrieving only active records from the data according to the saved changes to the data; and
recalculating the result based upon the active records.

9. The method of claim 8, wherein the active records are stamped at the time of creation and any prior records are deactivated at the same time.

10. The method of claim 9, wherein the prior records comprise records that existed before the active records are time-stamped.

11. The method of claim 8, further comprising retaining all non-active records for auditing.

12. The method of claim 11, further comprising combining all active and non-active records to create an audit trail.

13. The method of claim 12, further comprising generating a report from the audit trail.

14. The method of claim 13, wherein the report comprises user data, such as who made the changes to the active records, and the time that the changes were made.
